(19) United States
(12) Patent Application Publication
(10) Pub. No.: US 2026/0312236 A1
(43) Pub. Date: Oct. 8, 2026

(54) BATTERY COMPRISING AT LEAST ONE STACK OF ELECTRICAL CELLS AND ASSOCIATED ASSEMBLY METHOD

(71) Applicant: SAFRAN ELECTRICAL & POWER, Blagnac Cedex (FR)

(72) Inventors: Kevin Kappler, Moissy-Cramayel (FR); Frédéric Pinard, Moissy-Cramayel (FR); Sébastien Thomassier, Moissy-Cramayel (FR)

(73) Assignee: SAFRAN ELECTRICAL & POWER, Blagnac Cedex (FR)

(21) Appl. No.: 19/480,119

(22) PCT Filed: May 14, 2024
(86) PCT No.: PCT/FR2024/050617

§ 371 Date: Oct. 30, 2025

(30) Foreign Application Priority Data
May 16, 2023 (FR) FR2304845

(51) Int. Cl. H01M 50/474; H01M 10/04; H01M 10/613; H01M 10/625; H01M 10/653; H01M 10/6556; H01M 10/6568; H01M 50/264; H01M 50/48

(52) U.S. Cl. CPC H01M 50/474; H01M 10/0468; H01M 10/613; H01M 10/625; H01M 10/653; H01M 10/6556; H01M 10/6568; H01M 50/264; H01M 50/48; H01M 2220/20

(57) ABSTRACT

The invention relates to an electrical energy storage battery comprising at least one stack of electrical cells, a housing including a base to which said stack of the battery is attached, and a shell covering the base. The battery comprises at least two compression plates disposed on either side of said stack, means for attaching said plates to the base, and at least one tie rod capable of compressing the compression plates against the cells of said stack. The base comprises means for the thermal management of the electrical cells.

### TECHNICAL FIELD

The present invention relates to the storage of electrical energy, in particular in the field of aeronautics. It generally relates to the storage of electrical energy, for applications wherein mass is an important issue.

### PRIOR ART

Conventionally, in the field of aeronautics, the storage of electrical energy is carried out using low-voltage Lithium-Ion batteries, typically with a voltage less than 120 V.

The term battery means a set of individual modules comprising each of the power elements arranged in series and/or in parallel in order to achieve the desired electrical voltage and electrical capacity.

Modern aircraft have increasing electrical energy requirements, which requires batteries to be configured accordingly. Indeed, climate change is a major concern for many legislative and regulatory bodies around the world. Various restrictions on carbon emissions have been, are or will be adopted by various States.

Civil aviation has been mobilizing for several years now to contribute to the fight against climate change.

Technological research efforts have already made it possible to significantly improve the environmental performance of aircraft. Consequently, the Applicant continuously works to reduce its negative climate impact through the use of methods and the exploitation of proper development and manufacturing methods and minimizing greenhouse gas emissions to the minimum possible, in order to reduce the environmental footprint of its activity.

This sustained research and development work relates both to the new generations of aircraft engines, making aircrafts lightweight, particularly through the materials used and lighter on-board equipment, developing the use of electrical technologies to provide propulsion, and finally aviation biofuels.

In order to provide the necessary electrical power while minimizing the weight of the electrical equipment, it is important to increase the voltage of the batteries, for instance, to 800 V.

Inside high-voltage batteries, the power elements or battery cells are generally grouped into modules, each containing a specific number of cells, including devices for mechanical attachment, electrical connection, and potentially temperature regulation.

In order to improve the integration of the battery in terms of volume and mass, it is possible to stack the cells.

In this respect, document FR 3 067 859 A1 describes a battery comprising a stack of a plurality of cells assembled by means of mechanical attachment devices comprising frames or shells wherein the cells are inserted. This assembly multiplies the number of mechanical interfaces and does not make it possible to optimize the integration in terms of volume and mass. Furthermore, the presence of thermally insulating frames or shells disrupts the heat exchange within the battery, complicating the thermal management of the battery.

Moreover, battery modules exist comprising stacked cell assemblies, held in compression using four tie rods. The presence of such a large number of tie rods negatively affects the integration balance in terms of volume and mass. Moreover, the thermal management of such assemblies is not considered.

### DISCLOSURE OF THE INVENTION

The aim of the invention is therefore to propose a battery for storing electrical energy, particularly for an aircraft, of which the integration in terms of volume and mass is improved, and of which the thermal management is facilitated.

The object of the invention, in a first aspect, is a battery for storing electrical energy comprising at least one stack of electrical cells, a housing including a base on to which said stack of the battery is attached, and a shell covering the base.

The battery comprises at least two compression plates disposed on either side of said stack, means for attaching said plates to the base, and at least one tie rod capable of compressing the compression plates against the cells of said stack, the number of tie rods being exactly one unit greater than the number of stacks.

Furthermore, the base comprises means for the thermal management of the electrical cells.

The use of stacked electrical cells in such a battery makes it possible to improve the integration in terms of volume and of mass. The thermal management of the electrical cells is facilitated by the heat exchange with the base. Using compression plates on either side of the stack particularly makes it possible to reduce the need for including other mechanical compression elements, such as extra tie rods.

Using a number of tie rods exactly one unit greater than the number of stacks, makes it possible to have a smaller number of tie rods in relation to the battery modules of the prior art and results in significant mass gains.

According to a preferred feature of the invention, the tie rods are provided only in the upper portion of the compression plates.

Thus, advantageously, a stack of cells can be effectively held by only two tie rods connected to the compression plates.

Preferably, each stack of cells comprises an end foam layer at each of the ends thereof, so that the compression plates are in contact with said end foam layers of the stacks.

For example, the battery comprises at least one thermal drain disposed on a first outer surface of at least one cell of each stack and/or comprises at least one intermediate foam layer disposed on a second outer surface of at least one cell of each stack, with the second outer surface being opposite the first.

According to one feature, the thermal drain comprises at least one graphite layer and at least one adhesive layer.

Preferably, the thermal drain is folded beneath the cell with which it is in contact, so as to form a contact surface between the drain and the base.

Such a configuration makes it possible to increase the heat transfers between the base and the cells.

According to another feature, the battery comprises an adhesive layer covering the contact surface between the drain and the base.

For example, the attachment means comprise first and second attachment elements, said first elements being attached to the base and intended to pass through holes arranged in the base plate of each compression plate, and said second attachment elements cooperating with the first attachment elements to attach the compression plates to the base.

Preferably, the first attachment elements attached to the base comprise at least one stud.

Preferably, said stud passes through a hole arranged at the base plate of the compression plate, and oriented in the direction of the lateral movement of the compression plate.

Preferably, the second attachment elements comprise at least one nut.

Advantageously, the base comprises adjustment means capable of imposing a lateral movement on a compression plate, so as to move said compression plate closer to or away from the center of the base, when said lateral movement is increased or decreased.

Such adjustment means make it possible to perfectly control the relative distance between the compression plates.

Preferably, the adjustment means comprise at least one cam capable of cooperating with a base plate of the compression plate.

Advantageously, the battery comprises a protective wall attached to the compression walls and disposed between the cells and the shell, so as to protect the shell in the event of thermal runaway of the cells.

For example, the battery comprises at least one intermediate wall fixed to the base, oriented parallel to the electrical cells and disposed inside each stack.

According to another aspect, the object of the invention is a method for assembling a battery as described above, comprising the following steps:
installing a first compression plate,
installing at least one stack of electrical cells against the first plate,
installing a second compression plate opposite the first plate, disposed in contact with the stack of cells,
pressing the two compression plates against the stacks,
gradually moving the two compression plates closer,
after the plates have been moved closer, attaching the compression plates to the base, and installing the tie rods, and
tensioning the tie rods.

According to another aspect, the invention relates to an aircraft including at least one battery for storing electrical energy comprising at least one stack of electrical cells, the battery being as defined above according to the first aspect.

### BRIEF DESCRIPTION OF THE DRAWINGS

Other aims, features and advantages of the invention will become apparent upon reading the following description, given only by way of non-limiting example, and made with reference to the appended drawings wherein:

FIG. 1 is a schematic perspective view of a battery for storing electrical energy according to one embodiment of the invention;

FIG. 2 is a perspective view of the battery of FIG. 1, wherein the shell of the housing has been removed;

FIG. 3 is a side view of the battery of FIG. 2;

FIG. 4 is a perspective view of a detail of the connection between a compression plate and the base of the battery of FIG. 2;

FIG. 5 is a partial perspective view of a battery according to one embodiment of the invention; and

FIG. 6 is a flowchart of a method for assembling a battery according to one embodiment of the invention.

### DETAILED DISCLOSURE OF AT LEAST ONE EMBODIMENT

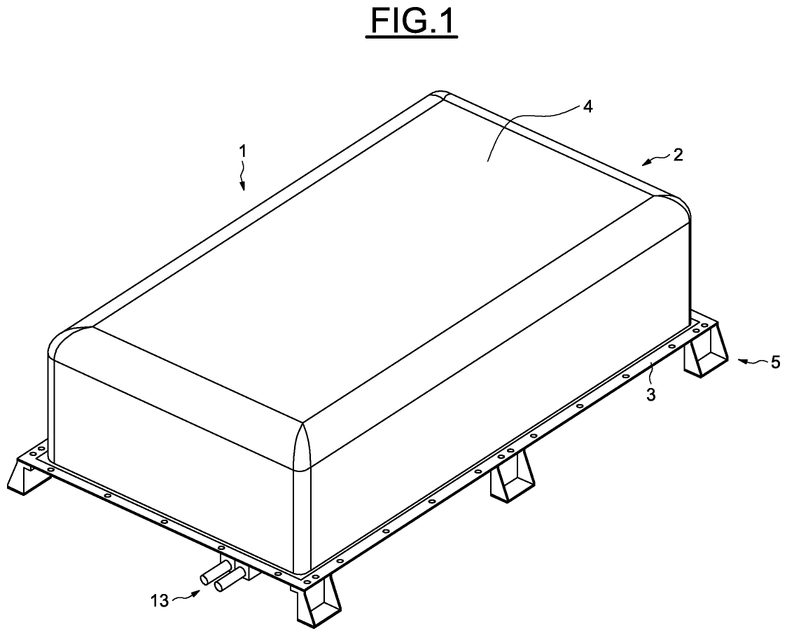

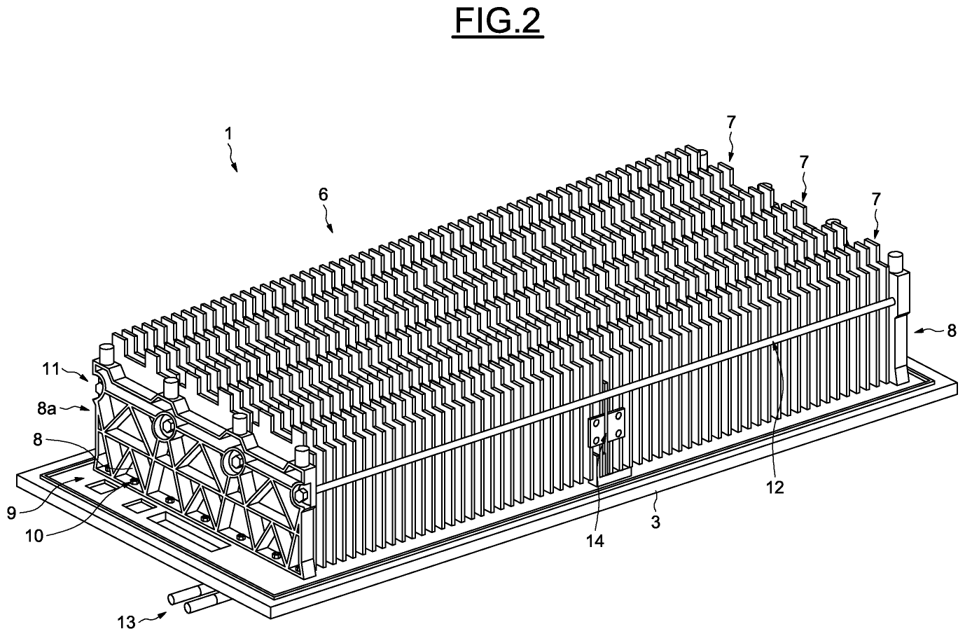

FIGS. 1 and 2 illustrate an example of embodiment of a battery for storing electrical energy in accordance with the invention, designated by the general numerical reference 1.

The battery 1 comprises a housing 2 including a base 3 and a shell 4. The housing 2 is intended to ensure the assembly, the connectivity, and the protection of the power components of the battery 1, that can be seen in FIG. 2, wherein the shell is not shown.

The housing 2 is provided with means for mechanically attaching the shell to the base, produced for example in the form of screws, bolts or any other appropriate attachment means for the intended use.

In the described embodiment, the battery 1 is intended to be placed on board an aircraft. However, it should be noted that the invention also applies, in general, to other fields and environments wherein mass management and integration problems arise.

Moreover, the base 3 is equipped with several attachment elements 5 that make it possible for it to be installed on board an aircraft. However, it should be noted that the base 3 may alternatively be formed of a structural support element of the aircraft provided for integrating the battery.

As regards the shell 4, it covers all of the elements located inside housing 2 and represents a physical barrier that separates and protects the interior of the housing 2 from the external environment thereof.

The shell 4 is particularly intended to reduce the risk of gas leaks. Preferably, a seal is implemented between the base 3 and the bell 4 to contain the gases.

Moreover, in the event of a thermal runaway of the battery 1, the shell 4 ensures a function of protecting the external environment of the housing 2 by limiting the impact of this event on the external environment of the housing 2.

The power elements of the battery 1 comprise electrical cells 6. The cells 6 are preferably in a prismatic flexible packaging format, commonly referred to as pouch.

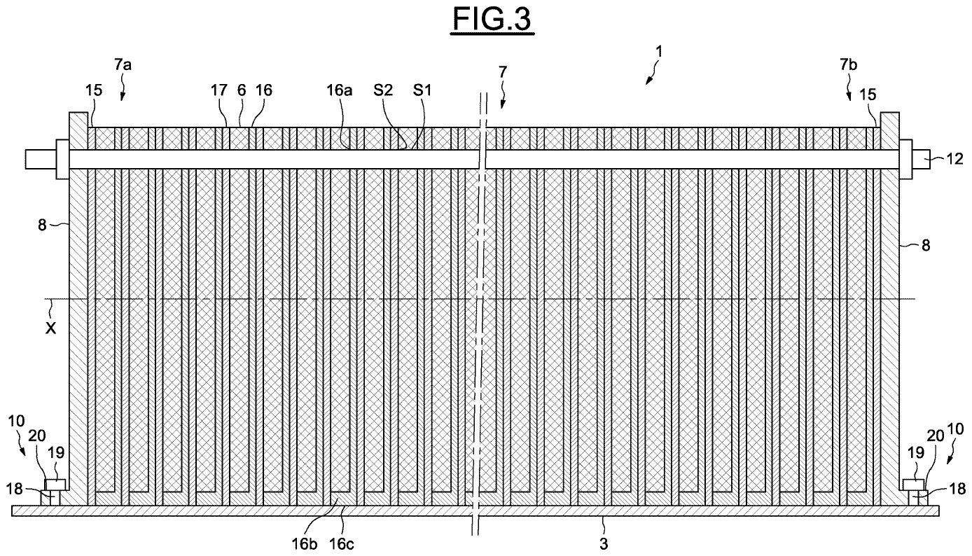

The electrical cells 6 are grouped into at least one stack 7. In other words, the cells of a stack are disposed side by side along the longitudinal axis X of the stack (FIG. 3). Preferably, the longitudinal axis X of the stack is parallel to the base 3.

The battery 1 comprises at least two opposing compression plates 8, disposed on either side of the stacks 7 of cells 6. The compression plates 8 are here positioned laterally at the ends of at least one stack 7. Preferably, the number of compression plates is limited to two, that is one per side; however, it is still possible to provide a larger number of plates 8.

The compression plates 8 have a stiffness that makes it possible to respect the maximum permissible deformation criteria along the longitudinal axis X of the stack, under the maximum pressure applied by the cells 6. For example, the stiffness of the plates 8 is such that the maximum deformation is less than 0.1 mm.

In order to respect the maximum deformation criteria while reducing the mass, the compression plates 8 include stiffeners 8a.

The compression plates 8 are preferably substantially flat and extend orthogonally to the longitudinal axis X of the stack of cells.

The compression plates 8 are attached by the lower portion 9 thereof to the base 3 using attachment means 10.

In the present example, the compression plates 8 are connected to one another by the upper portion 11 thereof by at least one tie rod, preferably by tie rods 12.

Preferably, the tie rods 12 are installed in a direction parallel to the longitudinal axes X of the stacks 7 and parallel to the base 3.

Advantageously, the number of tie rods 12 is reduced in relation to solutions used conventionally wherein the tie rods are present both in the lower and upper portions of the compression plates. The tie rods 12 are here preferably disposed only in the upper portion 11 of the compression plates 8. Thus, a single stack of cells may be held by only two tie rods. Alternatively, a single tie rod 12 could be disposed only in the upper portion 11 of the compression plates 8 to further decrease the number of tie rods.

The result here is a total number of tie rods 12 one unit greater than the number of stacks 7. In the example illustrated in FIG. 2, four tie rods 12 are present for three stacks 7, i.e. one more than the number of stacks. This reduction in the number of tie rods makes better integration in terms of mass and volume possible.

The base 3 is capable of ensuring a thermal management functionality and is to this end associated with thermal management means. The thermal management means may particularly comprise at least one heat exchanger 13, provided with pipes, inside of which a heat transfer fluid circulates. The heat transfer fluid is for example a coolant. For example, the heat exchanger 13 has a spiral shape. The base 3 is advantageously made of a thermally conductive material, particularly a metal material.

The heat exchanger 13 is for example integrated into the base 3, which optimizes the thermal pathway between the cells and the fluid, by reducing the thermal resistances related to the passages between components. Alternatively, the heat exchanger may be installed for thermal exchange with the base 3, preferably with an outer face of the base 3, that is to say the face opposite the inner face that houses the cells 6.

The base 3 is in thermal exchange with electrical cells 6 and can consequently bring and maintain the cells 6 at optimal operating temperatures.

The battery 1 preferably comprises at least one intermediate wall 14 attached to the base 3, oriented parallel to the electrical cells 6 and disposed inside each stack 7. FIG. 2 illustrates a single intermediate wall 14 disposed in a central area of the base 3, corresponding approximately to the middle of the base 3. Alternatively, it is still possible to provide a plurality of intermediate walls, disposed at regular intervals with each stack. Preferably, the intermediate walls 14 extend over most of the width of the base 3.

The presence of intermediate walls 14 contributes to stiffening the stacks 7 and has the effect of limiting the deformations in a direction normal to the base 3. The presence of intermediate walls 14 contributes to the good vibration resistance of the battery 1.

With reference to FIG. 3, each stack 7 comprises at each of the ends 7a and 7b thereof, an end foam layer 15.

Each cell 6 comprises a first outer surface S1 and a second outer surface S2 opposite the first.

In the embodiment illustrated in FIG. 3, the first outer surface S1 of each cell 6 is in contact with a thermal drain 16 and the second outer surface S2 is in contact with a foam layer 17, 15. Alternatively, it is still possible that only certain cells 6 of a given stack are in contact with a thermal drain and/or a foam layer 17, 15, or even that the cells 6 are not in contact with a drain or a foam layer 17. Here, the stack comprises two end foam layers 15 and a plurality of intermediate foam layers 17. The foam layers 15 and 17 ensure a thermal insulation function and have an elasticity capable of compensating the dimensional variations of the cells 6 during the operation thereof, while returning a pressure compatible with the permissible limits of the cells 6.

The foam layers 15, 17 may particularly comprise reinforcement fibers, an aerogel, a neoprene, and/or a thermoplastic.

The number of foam layers 17 necessary for compensating for the dimensional variation of the cells 6 depends on the type of cells used. Thus, depending on the chemistry of the cells 6, it is possible to drastically reduce the number of foam layers 17, or even eliminate them.

The thermal drain 16 comprises at least one graphite layer and at least one adhesive layer. The graphite layer of the thermal drain 16 is placed in contact with the external surface S1 of the associated cell 6 in order to maximize the heat transfer capacity between the drain and the associated cell.

In a particular embodiment, the thermal drain 16 comprises a metal layer, for example made of aluminum or of copper, combined with an adhesive layer and a graphite layer.

Each thermal drain 16 comprises a main portion 16a and a terminal portion 16b. The main portion 16a is oriented in a direction perpendicular to the longitudinal axis X of the stack, which is normal to the surfaces S1 and S2 of the cells 6. In other words, the main portions 16a of the thermal drains 16 are parallel to the surfaces S1 and S2. The main portion 16a is in contact with the surface S1 of the associated cell 6, and the terminal portion 16b is folded beneath the associated cell 6 to form a contact surface 16c of the drain 16 with the base 3.

Preferably, an adhesive layer covers the contact surface 16c of the drain 16 with the base 3, in order to reduce the risk of relative movement between the drains and the base.

The attachment means 10 of the compression plates 8 comprise first attachment elements 18 and second attachment elements 19. The first attachment elements 18 are attached to the base 3. They are intended to pass through holes arranged in a base plate 20 of each compression plate 8 and cooperate with the second attachment elements 19 to attach the compression plates 8 to the base 3. The first attachment elements 18 may in particular be studs, threaded rods or bolts. The second attachment elements 19 may be nuts.

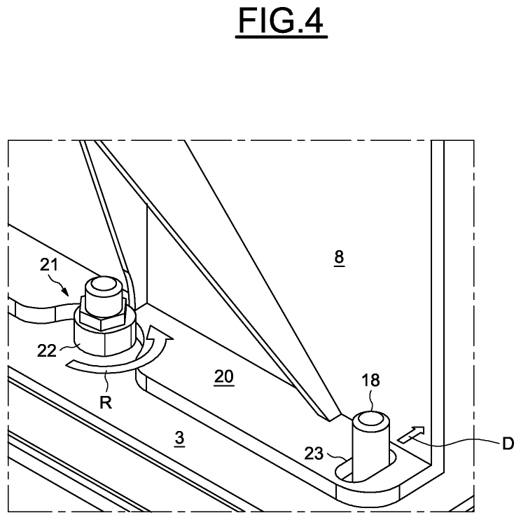

In the embodiment illustrated in FIG. 4, the base 3 is provided with adjustment means 21 capable of imposing a lateral movement D on at least one compression plate 8. The lateral movement is imposed here by a rotation R of a cam 22 the profile of which is in contact with the plate 8 and which presses thereon. The profile of the cam 22 may, for example, press against the edge of the base plate 20. The position of the plate 8 may be adjusted according to the rotation R of the cam, so as to move the compression plate 8 closer to or away from the middle of the base 3 when the lateral movement D imposed by the rotation R is respectively increased or reduced.

In this embodiment, each first attachment element 18 passes through an oblong hole 23 arranged in the base plate 20, and oriented in the direction of the lateral movement D to allow for this movement.

The use of such adjustment methods 22 makes it possible to protect against potential negative consequences of manufacturing tolerances. Thus, it becomes possible to precisely adjust the longitudinal distance between the compression plates 8 and to make it possible to control the pressure applied to the stacks 7 of cells 6 better.

Thus, on the one hand, thanks to the presence of the two compression plates 8 on the sides, and on the other hand, thanks to the precise mechanical attachment of the compression plates 8 to the base 3 using attachment means 10 (comprising for example studs as described above), the base 3 contributes to the compression of the cells 6 and the holding thereof in the stack 7.

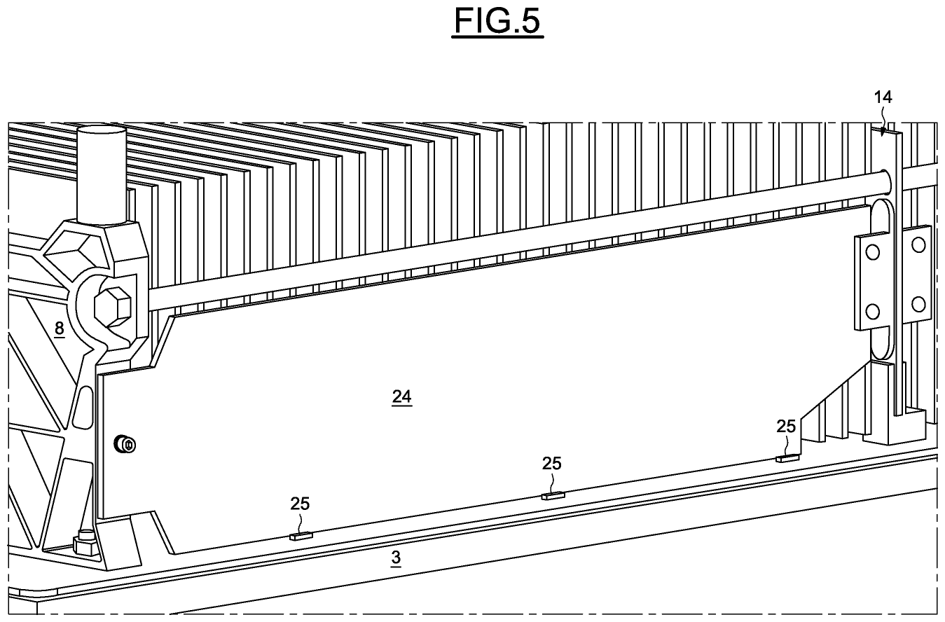

With reference to FIG. 5, according to a possible alternative embodiment, the battery is provided with a protective wall 24 attached to the compression walls 8 and disposed between the electrical cells of the battery and the shell 4, so as to protect the shell 4 in the event of thermal runaway of the cells.

The protective wall 24 is vertically supported by the base 3 and rests laterally on the projections 25 provided on the base 3.

The protective wall 24 may further be attached to the intermediate walls 14.

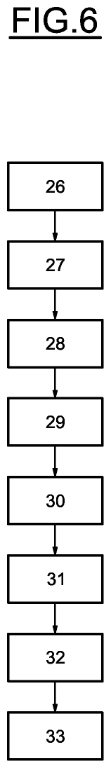

FIG. 6 is a flowchart of a method for assembling a battery 1 according to a possible example of embodiment of the invention.

The method begins with step 26 of installing a first compression wall 8 at a first predetermined dimension.

During the next step 27, at least one stack 7 of electrical cells 6 is installed against the first plate 8. Each stack 7 is preferably installed at a second predetermined dimension, different from the first, so that the edge intended to be in contact with the base 3 is further away from the center of the stack than the edge of the base plate 20 also intended to be in contact with the base 3. This gap between the first dimension and the second dimension is referred to as “negative clearance.” Alternatively, a flexible seal may be provided beneath each cell 6 while also creating a negative clearance.

A second compression plate 8, opposite the first and disposed in contact with the stacks 7 of cells 6, is subsequently installed (step 28). The second compression plate is installed at the same initial dimension as the first compression plate 8.

The method continues with a step 29 of pressing the two compression plates 8 against the stack of cells using pressurization equipment. The pressurization means may particularly comprise hydraulic cylinders, preferably ones that can be controlled while in motion.

During the next step 30 of bringing closer together, the two compression walls 8 are gradually moved closer together by controlling the pressurization means. The control is preferably of displacement to ensure precise management of the relative position of the compression plates 8.

When the two compression plates 8 have been moved closer, the method continues with step 31 of attaching the compression plates to the base 3, followed by step 32 of installing the tie rods 12. Alternatively, step 32 of installing the tie rods 12 may be performed before step 31 of attaching the plates 8 to the base 3.

It should be noted that during the assembly of the base 3 and of the compression plates 8, the negative clearance between the stacks 7 and the compression plates 8 leads to an increased pressure between the stacks 7 and the base 3. This additional pressure improves the heat exchange coefficient between the stacks 7 and the base 3.

When the battery is equipped with thermal drains 16, the method may comprise an optional step of applying an adhesive layer to the contact surfaces 16b of the thermal drains 16 with the base 3. The adhesive layer and the additional pressure between the stacks 7 and base 3, created by the previously described negative clearance, help to maintain the contact between the thermal drains 16 and the base 3.

The method ends with the tensioning of the tie rods 12 (step 33). Tensioning of the tie rods can be performed by removing or deactivating the pressurization means used during the previous steps of pressing and moving closer. In addition, the tension of the tie rods 12 could be increased, for example using active anchors. The tension forces of the tie rods 12 are balanced by the compression forces acting on the compression plates 8.

1. Electrical energy storage battery comprising at least one stack of electrical cells, a housing including a base to which said stack of the battery is attached and a shell covering the base, at least two compression plates disposed on either side of said stack, means for attaching the compression plates to the base, and at least one tie rod capable of compressing the compression plates against the cells of said stack, the base comprising means for the thermal management of the electrical cells, the number of tie rods being exactly one unit greater than the number of stacks.

2. Battery according to claim 1, wherein each stack of cells comprises at each of the ends thereof, an end foam layer so that the compression plates are in contact with said end foam layers of the stacks.

3. Battery according to claim 1, comprising at least one thermal drain disposed on a first outer surface of at least one cell from each stack and/or comprising at least one intermediate foam layer disposed on a second outer surface of at least one cell of each stack, with the second outer surface being opposite the first.

4. Battery according to claim 3, wherein said thermal drain comprises at least one graphite layer and at least one adhesive layer.

5. Battery according to claim, wherein said thermal drain is folded beneath the cell with which it is in contact, so as to form a contact surface of the drain with the base.

6. Battery according to claim 1, wherein the attachment means comprise first and second attachment elements, said first elements being attached to the base and intended to pass through holes arranged in a base plate of each compression plate, said second attachment elements cooperating with the first attachment elements to attach the compression plates to the base.

7. Battery according to claim 6, wherein the base comprises adjustment means capable of imposing a lateral movement on at least one compression plate, so as to move said compression plate closer to or away from the middle of the base, when said lateral movement is respectively increased or decreased.

8. Battery according to claim 1, comprising a protective wall attached to the compression plates and disposed between the cells and the shell, so as to protect the shell in the event of thermal runaway of the cells.

9. Method for assembling a battery according to claim 1, comprising the following steps:
installing a first compression plate;
installing at least one stack of electrical cells against the first plate;
installing a second compression plate opposite the first plate, and disposed in contact with the stacks of cells;
pressing the two compression plates against the stacks;
gradually moving the two compression plates closer;
after the plates have been moved closer, attaching the compression plates to the base and installing the tie rods; and
tensioning the tie rods.
